(19) United States
(12) Patent Application Publication
(10) Pub. No.: US 2005/0280924 A1
(43) Pub. Date: Dec. 22, 2005

(54) Noise prevention apparatus and magnetic recording and reproducing apparatus having the same

(75) Inventors: Hyeong-seok Choi, Suwon-si (KR); Myoung-joon Kim, Suwon-si (KR); Dong-seok Lee, Seoul (KR); Bong-joo Kim, Suwon-si (KR); Jun-young Kim, Suwon-si (KR); Chung-hum Baik, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/134,313

(22) Filed: May 23, 2005

(30) Foreign Application Priority Data
Jun. 16, 2004 (KR) 2004-44350

(51) Int. Cl. G11B 5/56

(52) U.S. Cl. 360/84

(57) ABSTRACT

A noise prevention apparatus and a magnetic recording and reproducing apparatus having the same are provided to such that a microphone unit records sound produced from outside the magnetic recording and reproducing apparatus in an optimum state. The noise prevention apparatus includes a noise damping part installed adjacent to at least one noise source that produces a noise when the image and sound signals are recorded and reproduced for damping and discharging the noise produced from the noise source. The noise damping part includes a noise collecting member for collecting the noise and a noise damping member for damping and discharging the noise collected by the noise collecting member to the outside. The noise produced from the noise source when the image and sound signals are recorded and reproduced is collected by the noise collecting member and then damped to a minimum size by the noise damping member, so that the microphone unit may record the sound in the optimum state.

### CROSS-REFERENCE TO RELATED APPLICATIONS

This application claims the benefit under 35 U.S.C. § 119(a) of Korean Patent Application No. 2004-44350, filed on Jun. 16, 2004, the entire contents of which are hereby incorporated by reference.

### BACKGROUND OF THE INVENTION

1. Field of the Invention

The present invention relates to a magnetic recording and reproducing apparatus, such as a digital camcorder. More particularly, the present invention relates to a noise prevention apparatus and a magnetic recording and reproducing apparatus having the same that reduces noise produced from a noise source, such as a head drum and a capstan motor in a camcorder.

2. Description of the Related Art

Generally, a magnetic recording and reproducing apparatus, such as a camcorder, includes a head drum for recording an image signal photographed by a camera unit on a magnetic recording tape or reproducing the image signal from the magnetic recording tape. The head drum generally rotates at about 9,000 rpm and comes into contact with the magnetic recording tape to record the image signal on the tape or to reproduce the image signal from the tape. Thus, a loud noise results from the contact of the head drum with the magnetic recording tape and from the rotation of a drum motor that drives the head drum.

Such noise may be input to a microphone unit, which may be built in a main body of the camcorder for miniaturization of the camcorder, that collects and records sound produced from outside on the magnetic recording tape, and this deteriorates the sound quality of the recorded image.

In order to solve the problem, as shown in FIG. 1, a conventional camcorder 10 includes a soundproof pad 11 arranged under a camera unit 5 in a main body 1 for shielding a microphone unit 3 that collects the sound produced from the outside from the noise generated inside of the apparatus. The soundproof pad 11 shields the noise produced from a head drum 9 of a deck part 7.

Such a noise shielding structure, however, only shields the microphone unit 3 from noise generated inside of the apparatus, but cannot shield the noise coming via the outside of the microphone unit 3 after being produced by the head drum 9 of the deck part 7.

Accordingly, a need exists for an improved noise prevention apparatus for a magnetic recording and reproducing apparatus that substantially eliminates noise produced by the magnetic recording and reproducing apparatus.

### SUMMARY OF THE INVENTION

An aspect of the present invention is to provide a noise prevention apparatus and a magnetic recording and reproducing apparatus having the same that substantially reduces noise produced from a noise source in the magnetic recording and reproducing apparatus.

The foregoing and other aspects and advantages are substantially realized by providing a noise prevention apparatus for a magnetic recording and reproducing apparatus for recording and reproducing image and sound signals on and from a magnetic recording tape According to an exemplary embodiment of the present invention, the noise prevention apparatus includes a noise damping part installed adjacent to at least one noise source that produces a noise when the image and sound signals are recorded and reproduced for damping and discharging the noise produced from the noise source to an outside of the apparatus.

In a preferred embodiment, the noise source includes at least a head drum for recording and reproducing the image and sound signals on and from the magnetic recording tape. The noise source may also include a capstan motor that drives a capstan shaft to smoothly run the magnetic recording tape.

The noise damping part includes a noise collecting member for collecting the noise, and a noise damping member for damping and discharging the noise collected by the noise collecting member.

The noise collecting member has a noise collecting plate installed to shield at least one side of a space formed by a tape cassette and a main plate of a deck part for collecting the noise produced and discharged from the noise source toward the side of the space. Preferably, the noise collecting plate is formed in a ‘⊂’ shape (substantially C-shaped) or a straight shape.

The noise damping member includes a noise damping chamber having an inlet port for sucking the noise collected by the noise collecting member, and an outlet port for discharging the damped noise to the outside. Preferably, the outlet port is positioned opposite to a microphone unit for collecting sound produced from the outside.

Preferably, the noise damping chamber has a structure having an empty space and an inner wall of an acoustic absorbent.

Additionally, the noise damping chamber may be installed adjacent to one of a loading motor for loading and unloading the magnetic recording tape on and from the head drum and the capstan motor.

In another aspect of the present invention, a magnetic recording and reproducing apparatus includes a deck part including a head drum for recording and reproducing image and sound signals on and from a magnetic recording tape, a loading motor for loading and unloading the magnetic recording tape of a tape cassette on and from the head drum, and a capstan motor for driving a capstan shaft to smoothly run the magnetic recording tape. A noise damping part is installed in the deck part for damping and discharging a noise produced from at least the head drum and the capstan motor to an outside of the deck part.

In an exemplary embodiment, the noise damping part includes a noise collecting member installed adjacent to at least one of the head drum, the loading motor, and the capstan motor for collecting the noise produced when the image and sound signals are recorded and reproduced. A noise damping member dampens and discharges the noise collected by the noise collecting member.

The noise collecting member preferably has a noise collecting plate installed to shield at least one side of a space formed by a tape cassette and a main plate of the deck part for collecting the noise produced and discharged from the head drum and the capstan motor toward the side of the space. Preferably, the noise collecting plate is formed in a ‘⊂’ shape (substantially C-shaped) or a straight shape.

The noise damping member includes a noise damping chamber having an inlet port for sucking the noise collected by the noise collecting member, and an outlet port for discharging the damped noise to the outside. Preferably, the outlet port is positioned opposite to a microphone unit for collecting sound produced from the outside.

Preferably, the noise damping chamber has a structure having an empty space and an inner wall of an acoustic absorbent.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a schematic view of a conventional camcorder;

FIG. 2 is a schematic view of a camcorder employing a noise prevention apparatus according to an exemplary embodiment of the present invention;

FIG. 3 is a perspective view of the noise prevention apparatus and a deck part of the camcorder of FIG. 2;

FIG. 4 is a partially broken plan view of the noise prevention apparatus of FIG. 3; and

FIG. 5 is a partially broken plan view of a modified noise prevention apparatus according to an exemplary embodiment of the present invention.

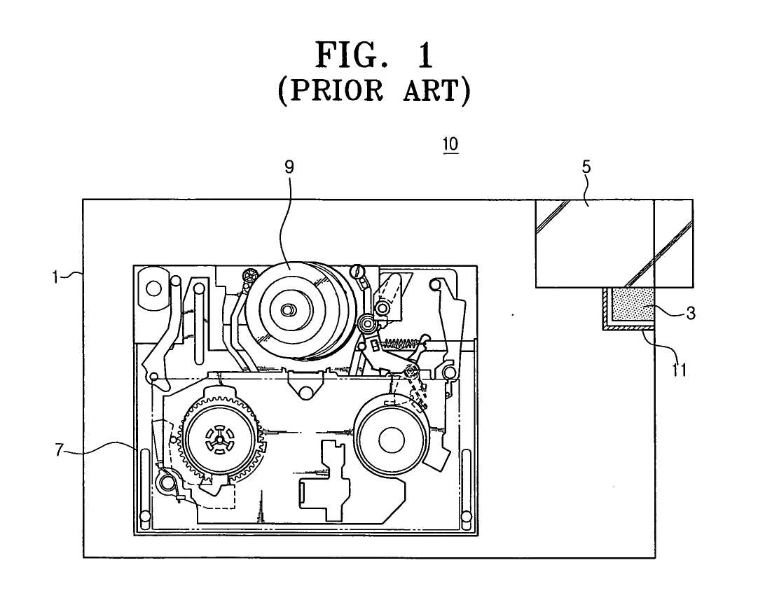

In the drawings, it should be understood that like reference numerals refer to like features and structures.

### DETAILED DESCRIPTION OF EXEMPLARY EMBODIMENTS

Certain embodiments of the present invention are described in greater detail with reference to the accompanying drawings.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description of the exemplary embodiments of the present invention.

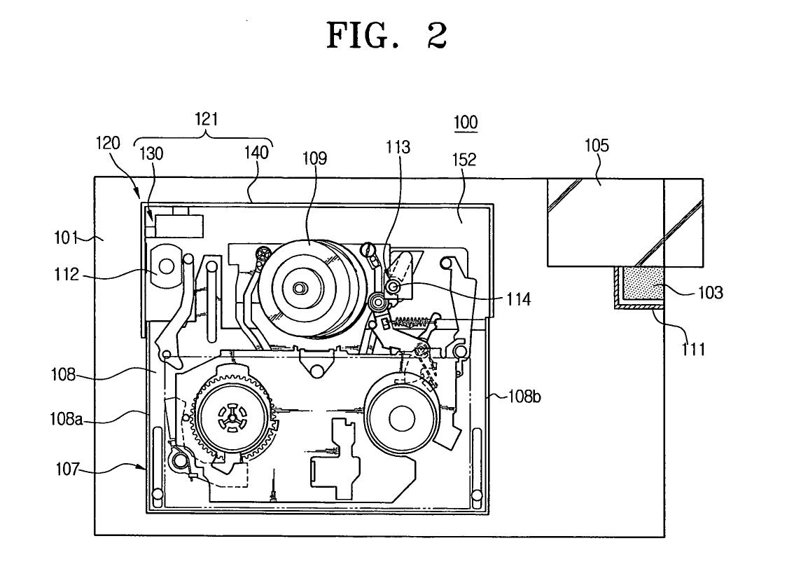

FIG. 2 is a schematic view of a camcorder 100 employing a noise prevention apparatus according to an exemplary embodiment of the present invention.

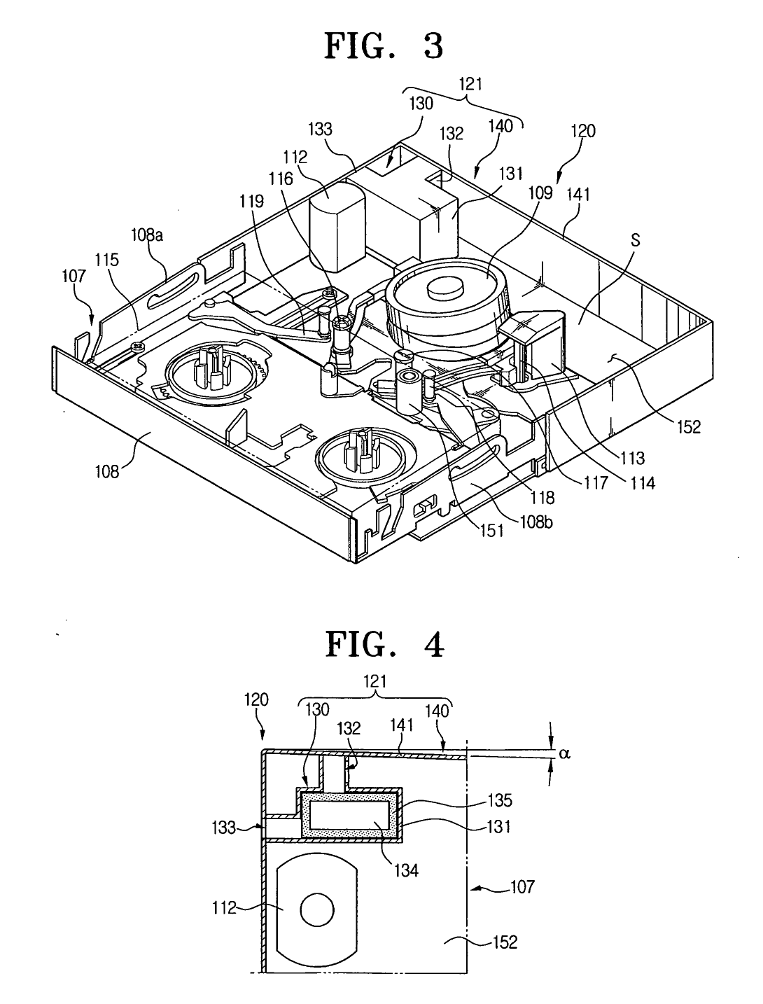

The camcorder 100 includes a microphone unit 103, positioned under a camera unit 105 for photographing an image in a main body 101, for collecting a sound produced from an outside. A deck part 107 records and reproduces the image photographed by the camera unit 105 and the sound collected by the microphone unit 103 on and from a magnetic recording tape (not shown) of a tape cassette (115 in FIG. 3). A noise prevention apparatus 120 is installed in the deck part 107 for damping and discharging the noise produced from the deck part 107 when the image and sound signals are recorded and reproduced.

The microphone unit 103 includes a soundproof pad 111 for shielding an inside of the apparatus to shield the sound produced in the main body 101.

The deck part 107 includes a main plate 152 fixed to the main body 101, and a sub-plate 108 fixing a tension arm 119 having a tension pole and being movable with respect to the main plate 152. A head drum 109 is installed at an upper center (FIG. 2) of a first surface of the main plate 152 for recording and reproducing the image and sound signals on and from the magnetic tape. A loading motor 112 is installed at one side of the upper portion of the first surface of the main plate for loading and unloading the magnetic recording tape on and from the head drum 109 by driving the sub-plate 108, first and second pole base assemblies 116 and 117 having guide rollers, and a review arm 118 through a specified driving mechanism (not shown). A capstan motor 113 is installed at the other side of the upper portion of the first surface of the main plate 152, that is, opposite to the loading motor 112, for driving a capstan shaft 114 to smoothly drive the magnetic recording tape in cooperation with a pinch roller 151.

Other constituent elements of the deck part and their operations, except for the main plate 152, the sub-plate 108, the head drum 109, the first and second pole base assemblies 116 and 117, the tension arm 119, the review arm 118, the loading motor 112, and the capstan motor 113, are identical with those of generally known deck mechanisms, and thus the detailed explanation thereof are omitted.

The noise prevention apparatus 120 of exemplary embodiments of the present invention is positioned on an upper portion of the deck part 107. This is because the deck part is provided on the upper portion thereof with a noise source, that is, the head drum 109 that is in contact with the magnetic recording tape and is driven by a drum motor (not shown) that produces noise. Also, in the lower portion (that is, the lower side of FIG. 2) of the deck part 107 and on the upper surface of the head drum 109, the noise produced by the head drum 109 is shielded by the tape cassette 115 mounted on the sub-plate 108 of the deck part 107 and an upper housing (not shown) of the deck part 107. However, the upper portion of the deck part 107 is open so that the noise produced by the head drum 109 is easily discharged.

Although the head drum 109 is explained as the noise source, it would be understood by one skilled in the art that the noise may also be produced by the capstan motor 113 that drives the capstan shaft 114 that is in contact with the magnetic recording tape together with a pinch roller 119, that is, the noise may also be produced from the contact among the magnetic recording tape, the pinch roller 119 and the capstan shaft 114, and the drive of the capstan motor 113.

The noise prevention apparatus 120 includes a noise damping part 121 installed adjacent to the head drum 109 for damping and discharging the noise produced when the image and sound signals are recorded and reproduced.

The noise damping part 121 has a noise collecting member 140 for collecting the noise, and a noise damping member 130 for damping and discharging the noise collected by the noise collecting member 140.

As shown in FIGS. 3 and 4, the noise collecting member 140 has a noise collecting plate 141 installed at an upper side (See FIGS. 2 and 4) of a rectangular parallelepiped space S, which is formed by the tape cassette 115 and the main plate 152 of the deck part 107, for collecting the noise discharged from the head drum 109 toward the upper side of the space S.

The noise collecting plate 141 is composed of a ‘⊂’-shaped (substantially C-shaped) plate extended from a first side wall 108a of the sub-plate 108 to a second side wall 108b for shielding an upper side and both sides of the space S.

The noise collecting plate 141 disperses the noise produced from the head drum 109 in left and right directions, and then collects the dispersed noise in the noise damping member 130.

Although the noise collecting plate 141 is described and shown as the ‘⊂’-shaped plate herein, it may be formed in a straight plate for sealing only the upper side of the space S according to a design of the deck part 107. For example, the first and second side walls 108a and 108b of the sub-plate 108 may be extended to the upper portion of the main plate 152 to seal both sides of the space S.

Additionally, the noise collecting plate 141 is described to be the plate only, but the surface of the plate may be coated with a soundproof material, such as an acoustic absorbent of a porous material (that is, fabric or sponge) to reflect and absorb the noise.

The noise collecting plate 141 may be inclined towards the noise damping member 130 at a certain angle α to a horizontal surface, as shown in FIG. 4, so that the noise produced from the head drum 109 is easily guided to and gathered in the noise damping member 130.

The noise damping member 130 has a noise damping chamber 131 positioned between the loading motor 112 and the noise collecting plate 141 on an upper portion of the loading motor 112.

The noise damping chamber 131 has a casing made of a resin material, and the casing includes an empty space 134 for damping the noise and an inner wall 135 provided with a soundproof material, such as an acoustic absorbent of a porous material (for example, sponge), for absorbing the noise.

The noise damping chamber 131 has an inlet port 132 that forms an inlet passage communicating with the space S together with the noise collecting plate 141 to suck the noise collected by the noise collecting plate 141 of the noise collecting member 140, and an outlet port 133 for discharging the damped noise to the outside.

Preferably, the outlet port 133 is positioned opposite to the microphone unit 103 for collecting the sound produced from the outside, that is, it faces the rear of the main body 101.

The noise damping chamber 131 is not sealed, but is instead formed with the outlet port 133 for discharging the noise to the outside, is to substantially prevent the deterioration of the noise canceling effect. Specifically, when the noise damped in the noise damping chamber 131 is not discharged to the outside, the damped noise is again reflected from the noise damping chamber 131 to the space S, and is mixed with a new noise to cause other noise.

The noise produced from the head drum 109 and the like moves along the noise damping path of the noise collecting plate 141, the inlet port 132, the noise damping chamber 131, and the outlet port 133, and is then discharged to the outside with its size damped.

The operation of the camcorder 100 including the noise prevention apparatus 120 according to exemplary embodiments of the present invention is described with reference to FIGS. 2 to 4.

First, when the head drum 109 and the capstan motor 113 operate to record the image and the sound obtained from the camera unit 105 and the microphone unit 103 on the magnetic recording tape, noise is produced due to the contact of the head drum 103 and the capstan shaft 114 of the capstan motor 113 with the magnetic recording tape and the drive of the motor.

The produced noise collides against the noise collecting plate 141, and then disperses in the left and right directions. Part of the noise is collected by the noise collecting plate 141, and flows into the noise damping chamber 131 through the inlet port 132. The remaining noise moves to the ‘⊂’-shaped (substantially C-shaped) end of the noise collecting plate 141 positioned opposite to the noise damping chamber 131 and the cassette tape 115 along the noise collecting plate 141, and then reflects from them to flow into the noise damping chamber 131 through the inlet port 132.

Part of the noise flowing into the noise damping chamber 131 is absorbed and cancelled by the inner wall 135, while the remaining noise is reflected from the inner wall 135 into the empty space 134 and collides against the reflected noise, so that the noise is damped. The dampened noise is discharged from the deck part 107 through the outlet port 133. Then, the noise discharged from the deck part 107 collides against the main body 101 to be dampened, and the dampened noise is discharged towards the rear of the main body 101.

Most of the noise discharged towards the rear of the main body 101 is cancelled or dampened by the noise damping chamber 131 and the main body 101, and is discharged in the direction opposite to the microphone unit 103. Accordingly, the noise inputted to the microphone unit 103 is slight, so that the camcorder 100 records sound in an optimum state.

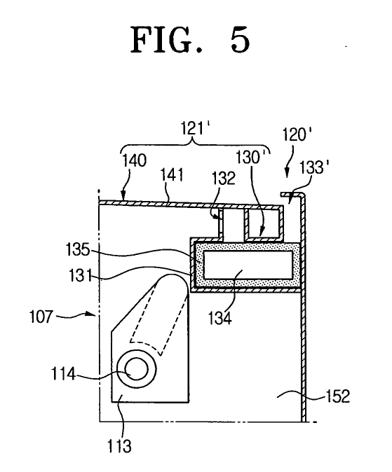

FIG. 5 illustrates a modified noise prevention apparatus 120′ according to an exemplary embodiment of the present invention.

The noise prevention apparatus 120′ is substantially similar to the noise prevention apparatus 120 shown in FIGS. 2 to 4, except that a noise damping member 130′ of the noise damping part 121′ is installed on the main plate 152 adjacent to the capstan motor 113. An outlet port 133′ of the noise damping chamber 131 is protruded towards the upper portion of the deck part 107, so that it is positioned opposite to the position of the microphone unit 103, that is, it faces on the rear of the main body 101.

The camcorder employing the noise prevention apparatus 120′ configured as described above operates in a similar manner to the camcorder 100 employing the noise prevention apparatus 120 as described and shown in FIGS. 2 to 4, and thus the detailed explanation thereof is omitted.

From the foregoing, it would be apparent to those skilled in the art that the noise prevention apparatus according to the present invention collects the noise produced from the head drum, the capstan drum, and the like, when the image and sound are recorded and reproduced by the magnetic recording and reproducing apparatus, dampens the collected noise to a minimum size in the noise damping chamber, and discharges the noise in the direction opposite to the position of the microphone unit. Therefore, the microphone unit may record sound in the optimum state.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

1. A noise prevention apparatus for a magnetic recording and reproducing apparatus for recording and reproducing image and sound signals on and from a magnetic recording tape, comprising:
a noise damping part installed adjacent to at least one noise source that produces a noise when the image and sound signals are recorded and reproduced for damping and discharging the noise produced from the noise source.

2. The noise prevention apparatus as claimed in claim 1, wherein
the noise source includes a head drum for recording and reproducing the image and sound signals on and from the magnetic recording tape and a capstan motor for driving a capstan shaft to smoothly run the magnetic recording tape.

3. The noise prevention apparatus as claimed in claim 1, wherein
the noise damping part has a noise collecting member for collecting a noise, and a noise damping member for damping and discharging the noise collected by the noise collecting member.

4. The noise prevention apparatus as claimed in claim 3, wherein
the noise collecting member has a noise collecting plate installed to shield at least one side of a space formed by a tape cassette and a main plate of the deck part for collecting the noise discharged from the noise source toward at least one side of the space.

5. The noise prevention apparatus as claimed in claim 4, wherein
the noise collecting plate is formed in one of a substantially C-shape and a straight shape.

6. The noise prevention apparatus as claimed in claim 4, wherein
an angle is formed between the noise collecting plate and a surface of the noise damping member to facilitate guiding the collected noise to the noise damping member.

7. The noise prevention apparatus as claimed in claim 4, wherein
the noise collecting plate is coated with a soundproof material.

8. The noise prevention apparatus as claimed in claim 3, wherein
the noise damping member includes a noise damping chamber having an inlet port for drawing in the noise collected by the noise collecting member and an outlet port for discharging the damped noise to outside of the noise damping member.

9. The noise prevention apparatus as claimed in claim 8, wherein
the outlet port is positioned opposite to a microphone unit that collects sound produced from the outside.

10. The noise prevention apparatus as claimed in claim 8, wherein
the noise damping chamber has an empty space and an inner wall of an acoustic absorbent.

11. The noise prevention apparatus as claimed in claim 8, wherein
the noise damping chamber is installed adjacent to one of the loading motor and the capstan motor.

12. A magnetic recording and reproducing apparatus, comprising:
a deck part including a head drum for recording and reproducing image and sound signals on and from a magnetic recording tape;
a loading motor for loading and unloading the magnetic recording tape of a tape cassette on and from the head drum;
a capstan motor for driving a capstan shaft to smoothly run the magnetic recording tape; and
a noise damping part installed on the deck part for damping a noise produced from the head drum and the capstan motor and discharging the noise from the deck part to outside of the deck part.

13. The magnetic recording and reproducing apparatus as claimed in claim 12, wherein
the noise damping part has a noise collecting member installed adjacent to at least one of the head drum, the loading motor, and the capstan motor for collecting the noise produced when the image and sound signals are recorded and reproduced, and a noise damping member for damping and discharging the noise collected by the noise collecting member.

14. The magnetic recording and reproducing apparatus as claimed in claim 13, wherein
the noise collecting member has a noise collecting plate installed to shield at least one side of a space formed by the tape cassette and a main plate of the deck part for collecting the noise discharged from the head drum and the capstan motor toward the at least one side of the space.

15. The magnetic recording and reproducing apparatus as claimed in claim 14, wherein
the noise collecting plate is formed in one of a substantially C-shape and a straight shape.

16. The magnetic recording and reproducing apparatus as claimed in claim 14, wherein
an angle is formed between the noise collecting plate and the noise damping member.

17. The magnetic recording and reproducing apparatus as claimed in claim 13, wherein
the noise damping member has a noise damping chamber having an inlet port for drawing in the noise collected by the noise collecting member, and an outlet port for discharging the damped noise to outside the noise damping member.

18. The magnetic recording and reproducing apparatus as claimed in claim 17, wherein
the outlet port is positioned opposite to a microphone unit that collects sound produced from the outside.

19. The magnetic recording and reproducing apparatus as claimed in claim 17, wherein
the noise damping chamber has an empty space and an inner wall of an acoustic absorbent.

20. The magnetic recording and reproducing apparatus as claimed in claim 14, wherein
the noise collecting plate is coated with a soundproof material.
